(19) United States
(12) Patent Application Publication
(10) Pub. No.: US 2003/0198783 A1
(43) Pub. Date: Oct. 23, 2003

(54) Metallized fabric having rainbow and/or hologram images

(76) Inventor: Munzer Makansi, Signal Mountain, TN (US)

Correspondence Address: LAWRENCE ISAKOFF, 1425 DRAKE ROAD, WILMINGTON, DE, 19803, US

(21) Appl. No.: 10/128,723

(22) Filed: Apr. 22, 2002

(51) Int. Cl. B32B 3/00

(52) U.S. Cl. 428/172

(57) ABSTRACT

A fibrous sheet has an outer surface of fibrous elements embossed with a pattern of fine grooves that are substantially aligned from fibrous element to fibrous element, and which produces rainbow and/or hologram images on exposure to light. A thin layer of metal, deposited atop the embossed pattern of grooves, intensifies the rainbow and/or hologram images and significantly increases the resistance of the sheet to dry-cleaning-induced degradation of the images.

### BACKGROUND OF THE INVENTION

1. Field of the invention

This invention relates generally to a fibrous sheet that has a diffraction grating and/or hologram groove pattern embossed directly on the surface of the fibrous sheet. More particularly, the invention concerns such an embossed fibrous sheet, the diffraction grating and/or hologram groove pattern of which has been “metallized” (i.e., has had a thin layer of metal deposited thereon), without detrimentally affecting the flexibility and breathability of the sheet or fabric.

2. Description of the Prior Art

It is known to produce hologram or rainbow images by diffracting light from patterns of very fine grooves that were embossed on various sheet-like materials, such as films, metal foils, and papers or fabrics coated or laminated with plastic. However, such sheet-like materials typically lack flexibility and breathability (i.e., porosity). Some such impermeable sheet-like materials, have been “metallized” for the purposes of enhancing hologram color intensity.

It is also known in the art to metallize permeable fabrics which have no embossed grooves for hologram or rainbow images, for the purpose of changing the thermal properties and visual aesthetics of the fabric. However, such metallizing limits the fabrics to only a few single solid colors, which colors are determined by the metal deposited on the fabric (e.g., a silver color from aluminum, red from copper, and golden yellow from gold). Any black, white or colored image which may have been printed or stitched on the fabric is obscured by the deposited opaque metal layer.

My earlier U.S. Pat. Nos. 5,882,770 and 6,120,710 disclose a fibrous sheet which has an outer surface comprising fibrous elements that are embossed with a pattern of fine grooves. The grooves are embossed directly on the surface of the fibrous sheet and are substantially aligned from fibrous element to fibrous element. The flexibility and breathability of the fibrous sheet is not detrimentally affected by the embossed pattern. On exposure to light the groove pattern produces rainbow and/or hologram images. The color and holographic images of such embossed fibrous sheets typically have good resistance to multiple cycles of washing with detergent, tumble drying and ironing. However, when such embossed fibrous sheets, especially those formed of fibers of synthetic organic polymers such as nylon, polyester or polyolefin, are subjected to multiple commercial dry cleaning cycles, I found that the image and color intensity fade significantly with each dry-cleaning cycle. Accordingly, an aim of the present invention is to overcome, or at least significantly ameliorate the fading problem associated with the dry cleaning of embossed flexible and breathable fibrous sheets.

### SUMMARY OF THE INVENTION

The present invention provides an improved fibrous sheet that has an outer surface comprising fibrous elements, preferably of thermoplastic polymer, which are embossed with a multiplicity of fine grooves. Most preferably, the fibrous elements are of a nylon, polyester or polyolefin polymer. The grooves of the fibrous sheet are substantially aligned from fibrous element to fibrous element and form a pattern that produces a rainbow and/or hologram image when the sheet is viewed at an angle to incident light. The improvement of the invention comprises a thin layer of metal, preferably of aluminum, deposited on the embossed surface fibrous elements of the sheet. The thickness of the metal layer is typically in the range of 0.005 micrometer to 3.0 micrometers, preferably in the range of 0.01 to 1.3 micrometers. The metal layer preferably is formed on the sheet by vacuum deposition. Surprisingly, the thin layer of metal not only enhances the visibility and color intensity of the rainbow and/or hologram images, but it also renders the images resistant to fading caused by multiple cycles of dry cleaning of the sheet with organic solvents.

### DETAILED DESCRIPTION OF PREFERRED EMBODIMENTS

The meanings of various terms used herein are as follows.

“Fibrous sheet” includes within its meaning knit, woven, nonwoven, spunbonded, spunlaced, stitch-bonded, felted fabric and the like.

“Fibrous element” includes within its meaning fiber, filament, thread, yarn, microfiber, fibril and the like.

“Fine grooves” means parallel grooves or segments of parallel grooves that are spaced apart uniformly by about 0.1 to 10 micrometers (microns) and are at least 0.01 micron deep. Groups of straight, parallel fine grooves, also known as “diffraction gratings”, produce rainbow colors, referred to herein as “rainbow images”. Groups of parallel fine groove segments having straight, curved or wavy configurations produce hologram images.

“Metallized” refers to a thin layer of metal deposited on the surface of a fibrous sheet of the invention.

In accordance with the present invention, an improved flexible, breathable fibrous sheet is provided. The sheet is of a known type having fibrous elements on its surface which are embossed with patterns of fine grooves that produce rainbow and/or hologram images. The images are visible to the naked eye when the sheet surface is viewed at an angle to incident sunlight or incandescent light. The patterns of fine grooves or clusters of groove segments on the individual fibrous elements of the sheet surface are substantially aligned from fibrous element to fibrous element and continue to neighboring fibrous elements in phase, such that the distance between the last groove on one fibrous element and the first groove on the neighboring fibrous element is an integer multiple of the groove width. The grooves are spaced apart uniformly by about 0.1 to 10 microns and are at least 0.01-micron deep.

In accordance with the improvement of the present invention, the above-described embossed sheet has a thin layer of metal deposited on its embossed surface. The metal layer is sufficiently thick to provide a continuous layer of metal coating over all exposed filament surfaces of the embossed sheet surface. The metal layer is sufficiently thin so that groove dimensions and alignments are not disturbed. Incomplete or discontinuous coverage of embossed sheet surface by the metal layer produces undesirable variability in color clarity and image resolution and results in poor resistance to dry cleaning. On the other hand, excessive deposition of metal on sheet surface, fills in the grooves and inter-filament spaces which causes the fabric to become stiff and lose, color brightness, image clarity and resolution. Typically, the thickness of the metal layer is in the range of 0.005 micron to 3.0 microns. Preferably, the metal layer thickness is in the range of 0.01 to 1.3 microns. Metal layer thicknesses of greater than about 3.5 microns produce less color intensification in light colored fabrics and can lead to stiffening and creasing in some thick fabrics.

Various metals can be employed for the metal layer of fibrous sheets of the invention. For example, aluminum, copper, silver, gold and the like are suitable. Aluminum, because of its lightness and low cost, is the preferred metal for the metal layer.

Several processes of metallizing the surface of an object are known in the art and are suitable for producing the metallized embossed fibrous sheet of the invention.

A preferred process for producing the metallized fabric of the invention is “vacuum metallizing”, a dry process that can be performed at high speed. Vacuum metallizing comprises: (a) placing an object to be metallized in a vacuum chamber that holds a series of crucibles or evaporation boats containing molten metal; (b) creating a vacuum in the chamber; and (c) advancing the object through the chamber so that the vapor from the evaporation boats causes metal to deposit onto the surface of the colder advancing object. Vacuum metallizing is commonly used in industry to metallize fabrics, films and papers.

A second suitable known method of metallizing a fibrous sheet of the invention is a wet electrolytic process. In the electrolytic process: (a) a cathode and an anode are positioned apart and opposite each other in a solution of a salt of the desired metal; (b) the object to be metallized is placed in the bath attached to, or as part of, the cathode; (c) a voltage is imposed across the electrodes to cause a direct electric current to pass through the bath and form positive and negative ions within the bath; and (d) the positive ions, which are metal atoms carrying positive charges, migrate to the cathode and are deposited on the surface of the object being metallized. In industry, this process generally has been used to make flexible electrically conducting tapes for grounding or shielding electronic equipment.

A third suitable known metallizing process is chemical metallizing. In this process, specific chemical agents are added to a solution containing ions of the desired metal to cause the metal ions to precipitate as metal atoms or molecules directly onto the surface of the object being metallized.

As a result of the above-described process of depositing a thin metal layer on the embossed fibrous surface of the fabric of the invention, the rainbow and/or hologram images have enhanced color, clarity and resolution, the fabric retains its breathability and flexibility, and the rainbow color and/or hologram images resist multiple cycles of fabric dry-cleaning without substantial loss of these other desirable characteristics.

The following methods and procedures are used to measure various characteristics of embossed and metallized fibrous sheets of the invention.

“Metal layer thickness”, t, is measured by one of two methods. In the first method, the weight, W₀ (in grams), of a sample of metallized fabric is determined and its metallized surface area, A, (in square centimeters) is measured. The metal layer is removed from the embossed fibrous sheet by dissolution in an appropriate solvent (e.g., an aqueous sodium hypochlorite solution for dissolving aluminum). The fabric sample is then rinsed thoroughly, dried and re-weighed, W_{f}. The difference between the initially determined weight of the metallized sample and the weight of the solution treated sample is then divided by the metallized surface area to obtain the amount of metal per unit area of fabric, which quantity is then divided by the density of the metal, d (in grams per cubic centimeters), to obtain the thickness, t, of the metal layer deposited on the fabric. Thus,

t (in centimeters)=(W₀−W_{f})/A.d.

A second method for determining the thickness of the metal layer consists of measuring the difference in unit weight (in grams per unit area) between a metallized fabric sample and a non-metallized sample (i.e., the fabric before metallization) and then dividing this difference by the density of the metal to obtain the thickness of the metal on fabric. Note that all weights are determined on samples that have been thoroughly vacuum dried and that in the Examples below the thickness is reported in microns (i.e. micrometers).

“Color brightness”, as used herein, is a subjective rating of the intensity of a rainbow or hologram image on the sheet surface, as observed with the naked eye when the sheet is viewed at an angle to incident light from a 100-watt incandescent light bulb or a 50-watt narrow floodlight halogen lamp. Color brightness is rated on a scale from zero to ten. A rating of zero indicates that no color is visible. A rating often in the Examples below indicates that the image is equivalent in brightness and color color intensity to the best obtained, from an embossed fabric without metallizing; that is, substantially equivalent to the brightness and color intensity from an image on the white polyester satin fabric embossed by the process of Example 14 of U.S. Pat. No. 6,120,710, the disclosure of which is incorporated herein by reference. All other numerical ratings are relative to the brightness of the samples at the limits of the zero-to-ten scale.

In the examples below, the color intensity of the hologram and/or rainbow image of each sample is rated after embossing after metallizing (except for Comparison Samples A-D which were not metallized) and after one, four and six “Versol” dry-cleaning cycles. Each dry-cleaning cycle is performed in commercial dry-cleaning equipment using a hydrocarbon dry-leaning solvent. Specifically, the solvent is a product of Shell Oil Company, trade-named “SHELL SOL HT” and identified as “solvent naphtha (petroleum) medium aliphatic” Shell code 83162, having a specific gravity of 0.77 g/cm³ at 19° C. and a boiling point range of 159 to 176° C. In the examples, this solvent is referred to as “Versol”. To assure that all samples are tested and rated under as nearly the same conditions as practicable, the following procedure was employed. Non-metallzed samples and metallized samples of the same embossed fabric were sewn side by side to form a wide master panel containing all the test samples. Narrower panels, each about 18-centimeters wide and containing a portion of each test sample, were cut from the master panel at several stages of the dry-cleaning tests; namely, before dry-cleaning, after one cycle, after four cycles and after six cycles of the commercial “Versol” dry-cleaning. The panels were then taped together on a backing to form a composite master panel, similar to the original master panel, so that all tested samples could be viewed and rated side by side, under the same lighting conditions.

### EXAMPLES

The following examples illustrate preferred embodiments of the invention. Fibrous sheets that had been embossed with patterns of fine groove which produce rainbow and/or hologram images are metallized in accordance with the invention. The fibrous sheet samples are made with thermoplastic fibers of nylon, polyester, or nylon/LYCRA® spandex blends. Each of the fabric samples, comparison samples as well as samples of the invention, had been embossed with fine hologram groove patterns by a continuous roll-embossing process of the type illustrated in FIG. 2 of U.S. Pat. No. 6,120,710, the entire disclosure of which is incorporated herein by reference. More specifically, fabric samples were slit to a width of 71 centimeters (28 inches) and passed through a 76-cm (30-in) wide nip formed by a heated metal embossing roll and back-up roll covered with a resilient material having a shore hardness of 98. Four comparison samples, identified as Comparison Samples A, B, C and D, and samples of the invention, Samples 1, 2, 3, 4 and 5, were embossed under the following conditions:

| Sample | Temperature | Speed | Nip Compression | |
|---|---|---|---|---|
| Designation | ° C. | meters/min | lbs/inch width | total Kg |
| Comparison | | | | |
| A | 160 | 3.3 | 600 | 1680 |
| B | 166 | 3.3 | 600 | 1680 |
| C | 166 | 3.3 | 800 | 2240 |
| D | 166 | 3.3 | 700 | 1960 |
| Of Invention | | | | |
| Sample 1 | 207 | 2.1 | 600 | 1680 |
| Sample 2 | 210 | 2.1 | 600 | 1680 |
| Sample 3 | 310 | 3.6 | 600 | 1680 |
| Sample 4 | 166 | 3.3 | 700 | 1960 |
| Sample 5 | 160 | 3.3 | 800 | 2240 |

For the samples of the invention illustrated here (Samples 1-5), metallizing of the embossed fibrous sheets was accomplished in commercial vacuum metallizing equipment, which deposited a thin layer of aluminum on the embossed surface of the fibrous sheet.

In the Examples, samples of the invention are identified with Arabic numerals and comparison samples are identified with upper case letters.

### Comparison Example

This example demonstrates the effects of dry-cleaning on the rainbow color and/or hologram images of embossed fibrous sheets that are not metallized (Comparison Samples A, B, C and D). These embossed samples would be of the invention, except that they are not metallized (i.e., do not have a thin layer of metal atop the embossed surface of the fibrous fabric). The detrimental effects of the dry-cleaning on the hologram color intensity rating are summarized in Table I below (after the description of each Comparative Sample). These results clearly demonstrate how rapidly the hologram images and colors fade and sometimes even completely disappear from the embossed fibrous sheets when the sheets are subjected to multiple dry-cleaning cycles.

Comparison Sample A, a navy-blue colored polyester twill fabric, style no. 784686, manufactured by Milliken & Co., USA, having 17-by-22 ends/cm and weighing 186 g/m²′, was embossed with a “Pillars of Light” hologram pattern (i.e., a pattern of parallel rainbow bands spaced apart by equal distances). The hologram color intensity rating of this fabric sample was 4.5 before any dry-cleaning. Upon subjecting Sample A to six cycles of commercial “Versol” dry-cleaning, the hologram color intensity rating decreased to 3.5 after the first cycle, to 2.0 after the fourth cycle and to 1.0 after the sixth cycle.

Comparison Sample B, a black colored polyester satin fabric, style no. 784750, manufactured by Milliken & Co. USA, having 16.5-by-20 ends/cm on the satin side and 24.5-by-27.5 ends on the back side and weighing 111 g/m², was embossed with a “Target” hologram pattern by substantially the same continuous process as Sample A. The hologram color intensity rating of this fabric sample after embossing, but before dry cleaning, was 4.0. Commercial “Versol” dry cleaning caused the color intensity rating to decrease to 2.0 after one cycle, to 1.0 after four cycles and to 0.5 after six cycles.

Comparison Sample C, a gray colored polyester knit fabric, style no. 692386, manufactured by Milliken & Co. USA, having 17-by-18.5 ends/cm and weighing 149 g/m², was embossed in the same way as Sample B with a “Target” hologram pattern. The hologram color intensity rating of this fabric was 1.0, as embossed. Commercial “Versol” dry cleaning of the fabric, caused the hologram color intensity rating to decrease to: 0.5 after one cycle, to about 0.3 after the fourth cycle and to zero after the sixth cycle.

Comparison Sample D, a black colored knit nylon/LYCRA spandex® blend foundation fabric, having 25 wales/cm-by-30 courses/cm and weighing 173 g/m²., was embossed with the same “Pillars of Light” hologram pattern as Sample A. As embossed, before dry-cleaning, the hologram color intensity rating of this fabric was 2.0. Dry-cleaning cycles caused the hologram color intensity rating to decrease to 1.0 after one cycle, to about 0.5 after four cycles and to 0.2 after six cycles.

TABLE I
Effect of dry-cleaning on holograms of non-metallized
Comparison fabrics

| | A | B | C | D |
|---|---|---|---|---|
| Comparison Sample | | | | |
| Fabric color | navy | black | gray | black |
| Fabric weight, g/m² | 186 | 111 | 149 | 173 |
| Color Intensity rating after dry cleaning | | | | |
| Zero cycles | 4.5 | 4.0 | 1.0 | 2.0 |
| One cycle | 3.5 | 2.0 | 0.5 | 1.0 |
| Four cycles | 2.0 | 1.0 | 0.3 | 0.5 |
| Six cycles | 1.0 | 0.5 | 0.0 | 0.2 |

### EXAMPLES OF THE INVENTION

In each of the following five examples, preferred embodiments of the invention, an embossed fibrous fabric (Samples 1, 2, 3, 4 and 5) having a thin aluminum layer vacuum deposited atop the embossed surface is subjected to the same dry-cleaning cycles as were Comparative Samples A, B, C and D. For each sample of the invention, the thickness of the deposited metal layer was measured and the hologram color intensity ratings of each fabric was rated after embossing (i.e., before metallizing), after metallizing, and after one, four and six cycles of commercial “Versol” dry cleaning. The results of the Examples, which are summarized in Table II below, clearly show the advantages of the metallized fibrous sheets of the invention over the non-metallized comparison sheets.

### Example 1

Sample 1, a white polyester satin fabric, having 15-by-29 ends/cm on the satin front side and 21.5-by-24 ends on the back side and weighing 101 g/m², was embossed in the same manner and with the same “Target” hologram pattern as Comparison Sample B. The hologram color intensity rating of this fabric after embossing (but before metallizing) was 2.0. The embossed fabric was metallized with aluminum by vacuum metallization. The measured difference in unit weight between the metallized fabric and non-metallized fabric, was of 1.3 g/m², which is equivalent to a 0.48-micron thick layer of aluminum metal deposited on the embossed surface of the fabric. As a result of the metallizing, the color intensity rating of hologram images increased from 2.0 before metallizing to 9.0 after metallizing. Subjecting embossed and metallized Sample 1 to six cycles of Versol dry cleaning in the same bath as for Comparative Samples A-D, caused the hologram color intensity rating to decrease very little; to: 8.8 after the first cycle, to 8.5 after the fourth cycle and 8.0 after the sixth cycle.

### Example 2

Sample 2, a white polyester satin fabric having 15-by-29 ends/cm on the satin front side and 21.5-by-24 ends on the back side and weighing 101 g/m² was embossed with a “Herringbone” hologram pattern. The hologram color intensity rating of the embossed fabric was 2.0. The embossed fabric was then metallized by vacuum metallization. As a result, the unit weight of the fabric increased by 0.29 g/m², which was equivalent to a 0.11-micron thickness of aluminum metal deposited on the embossed surface of the fabric. The hologram color intensity rating increased from 2.0 before metallizing to 9.0 after metallizing. Exposure of metallized Sample 2 to six Versol dry-cleaning cycles caused the hologram color intensity rating to decrease very little; to 8.8 after one cycle, to 8.5 after four cycles and to 8.0 after six cycles.

### Example 3

Sample 3, a white nylon oxford fabric, having 20-by-29 ends/cm and weighing 111 g/m², was embossed with a “Herringbone” hologram pattern. The hologram color intensity rating of the embossed fabric was 2.0. The embossed fabric was vacuum metallized with 1.66 g/m² of aluminum being deposited on the embossed surface, which is equivalent to an aluminum layer thickness of 0.6 micron. The metallizing resulted in an increase in hologram color intensity rating from 2.0 before metallizing to 9.0 after metallizing. Subjecting embossed and metallized Sample 3 to six cycles of a Versol dry cleaning caused the hologram color intensity rating to decrease a small amount; to 8.7 after one cycle, to 8.0 after four cycles and to 7.3 after six cycles.

### Example 4

The fabric of Sample 4, is the same embossed, black colored, knit nylon/LYCRA spandex® blend as was used in Comparison Sample D. The hologram color intensity rating of embossed fabric Sample 4 was 2.0. Vacuum metallization deposited 1.73 g/m² of aluminum on the embossed surface of the fabric, which was equivalent to a 0.64-micron thick layer of aluminum metal. As a result of the metal deposition, the hologram color intensity rating increased from 2.0 before metallizing to 3.5 after metallizing. Versol dry cleaning of the metallized fabric decreased the hologram color intensity rating only a little; to 3.3 after one cycle, still at 3.3 after four cycles and to 3.0 after six cycles.

### Example 5

Sample 5, a pink swimwear knit fabric of nylon/LYCRA® spandex blend having 20 wales/cm, 26 courses/cm and a weight of 165 g/m², is embossed with a “Target” hologram pattern to provide an embossed fabric having a hologram color intensity rating of 2.0. Vacuum metallization deposited 1.35 μm² of aluminum, equivalent to a 0.5-micron thick layer of aluminum on the embossed surface of the fabric. As a result of the metallization, the hologram color intensity rating increased from 2.0 before metallizing to 6.0 after metallizing. Six cycles of Versol dry cleaning, caused the hologram color intensity rating to decrease to 4.5 after one cycle, to 3.0 after four cycles and to 1.5 after sixth cycles. The comparatively large decrease for metallized samples is believed to have been caused by the stretchiness of the fabric, which made for difficulties in depositing a uniform metal layer.

TABLE II
Effect of dry-cleaning on hologram images of metallized fabrics

| | 1 | 2 | 3 | 4 | 5 |
|---|---|---|---|---|---|
| Sample of Invention | | | | | |
| Fabric color | white | white | white | black | pink |
| Fabric weight, g/m² | 101 | 101 | 114 | 173 | 165 |
| Metal layer thickness, microns | 0.5 | 0.1 | 0.6 | 0.6 | 0.5 |
| Color Intensity rating | | | | | |
| Before metallizing | 2.0 | 2.0 | 2.0 | 2.0 | 2.0 |
| After metallizing | 9.0 | 9.0 | 9.0 | 3.5 | 6.0 |
| After dry cleaning | | | | | |
| One cycle | 8.8 | 8.8 | 8.7 | 3.3 | 4.5 |
| Four cycles | 8.5 | 8.5 | 8.0 | 3.3 | 3.0 |
| Six cycles | 8.0 | 8.0 | 7.3 | 3.0 | 1.5 |

In contrast to the similarly dry-cleaned embossed fabric that had no metal layer (i.e., Comparative Samples A-D), the metallized embossed fabrics of the invention (i.e., Samples 1-5) show a surprisingly advantageous, strong resistance to dry-cleaning-induced hologram fading. In addition, even though the embossed fabrics of the invention exhibited relatively low brightness ratings before metallization (i.e., of 2.0), after vacuum deposition of a thin metal layer on the embossed surface of the fabric, each sample of the invention exhibited a significantly intensified image brightness and color (i.e., ratings increased to as high as 9.0). Note that the hologram color intensity ratings of the non-metallized Comparative Samples of Table I show that their hologram and/or rainbow color images faded rapidly or even disappeared after six dry-cleaning cycles (to ratings of 1.0 or lower). In sharp contrast, the hologram color intensity ratings of the metallized Samples of the invention summarized in Table II show that metallized fabics of the invention strongly resisted dry-leaning-induced degradation of the holograms and/or rainbow images.

Additional samples of the invention were prepared with a laboratory size vacuum metallizing equipment, Model SC-5000 high vacuum evaporator made by CVC Products of Rochester, N.Y. Vacuum deposited aluminum layers of 0.02- to 1.1-micron thickness were produced.

Several metallized, embossed fibrous sheets of the invention were wear-tested-in household applications After 1000 hours of testing as fixed covers on household and office furniture cushions, no signs of delamination of the metal layer were detected and no creases were found which could not be removed by conventional pressing or ironing.

Many different embodiments of the invention may be made without departing from the spirit and scope of the invention. The scope of the invention is not intended to be limited, except as set forth in the appended claims.

I claim:

1. An improved fibrous sheet having an outer surface comprising fibrous elements that are embossed with a multiplicity of fine grooves, said grooves being substantially aligned from fibrous element to fibrous element and forming a pattern that produces a rainbow and/or hologram image when the sheet is viewed at an angle to incident light, the improvement comprising said embossed fibrous sheet having deposited thereon a thin layer of metal, the layer having a thickness in the range of 0.005 micron to 3.00 microns.

2. An improved fibrous sheet in accordance with claim 1 wherein the thickness of the metal layer is in the range of 0.01 to 1.3 micrometers.

3. An improved fibrous sheet in accordance with claim 1 wherein the fibrous elements are of thermoplastic organic polymer and the metal layer is of aluminum.

4. An improved fibrous sheet in accordance with claim 1 wherein the thermoplastic organic polymer is a nylon, a polyester or polyolefin.
